(19) United States
(12) Patent Application Publication
(10) Pub. No.: US 2008/0155668 A1
(43) Pub. Date: Jun. 26, 2008

(54) PASSWORD SETTING METHOD, VIDEO RECEIVING SYSTEM, PROGRAM AND RECORDING MEDIUM

(75) Inventors: Nobuhiko ARASHIN, Osaka (JP); Kenji SHIOYAMA, Kyoto (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/961,129

(22) Filed: Dec. 20, 2007

(30) Foreign Application Priority Data
Dec. 25, 2006 (JP) 2006-348578

(51) Int. Cl. H04L 9/32

(52) U.S. Cl. 726/6

(57) ABSTRACT

A password setting method for setting a same password used for connecting to a network by multiple video receiving apparatuses retaining unique information different from one another, to said multiple video receiving apparatuses includes:
a password generation step in which a remote control apparatus for transmitting an operation signal with respect to said multiple video receiving apparatuses, or one video receiving apparatus among said multiple video receiving apparatuses generates said password based on said unique information retained by said one video receiving apparatus, and stores the password in a password storage unit provided in said remote control apparatus; and
a password transmitting step in which said remote control apparatus transmits said stored password to any other video receiving apparatus.

### BACKGROUND OF THE INVENTION

1. Field of the Invention

The present invention relates to a password setting method, a video receiving system, a program and a recording medium, for example, which set a password with respect to a video receiving apparatus connected via a network.

2. Related Art of the Invention

Recently, multiple devices installed in a premise have been often connected in a network configuration.

By connecting the multiple devices in the network, for example, a user having multiple video receiving apparatuses which are STBs for a cable television can accumulate contents in one video receiving apparatus and view the contents at another video receiver which has been connected in a premise network and installed in another room. Moreover, the user can also control states of the devices connected to the network and the like. What is important in such an environment of connecting the multiple devices in the network is to generate a group constituted by devices which are interconnected to one another and have a common password, for each premise.

As one method thereof, there has been proposed a method which causes multiple devices to share a password for connecting to a network by using a memory card which is a card type storage device employing a flash memory such as a PC card, and constitutes a group with devices selected and identified by a user (for example, see Japanese Patent Laid-Open No. 2004-254271).

It should be noted that the entire disclosure of the above described document is incorporated herein by reference in its entirety.

FIG. 14 shows a connection configuration diagram of a network system proposed in the same document.

Multiple network devices 101, 102 and 103 are connected via a network 100. Each of the network devices 101, 102 and 103 is provided with a PC card slot 104 into which a PC card is inserted.

When a blank memory card 105 is prepared and the memory card 105 is inserted into the PC card slot 104 of the network device 101, the network device 101 generates a password required for performing IPsec (Security Architecture for Internet Protocol) communication in the network 100, and registers the password in the memory card 105.

Next, when the memory card 105 in which the password has been registered is inserted into the network device 102, the password is set to the network device 102, and the network device 102 becomes able to use the password to connect to the network 100. Similarly, when the memory card 105 is inserted into the network device 103, the network device 103 also becomes able to connect to the network 100.

In this way, by causing the network devices 101, 102 and 103 to share the same password, communication among the network devices which have been authenticated by one another is enabled via the network 100.

Since the memory card 105 is used, the devices connecting to the network 100 authenticate one another as devices constituting a group, without retaining an apparatus specially including an authentication server or a key management unit, and a group which realizes secure communication can be easily generated and managed.

However, in the above described conventional network system, the user has to constantly manage the memory card for setting the password, which is not convenient for the user.

### SUMMARY OF THE INVENTION

The present invention solves the above described conventional problem, and it is an object of the present invention to provide a password setting method, a video receiving system, a program and a recording medium which set a password with respect to a video receiving apparatus connected via a network, in a convenient way for a user.

To solve the above problem, the first aspect of the present invention is a password setting method for setting a same password used for connecting to a network by multiple video receiving apparatuses retaining unique information different from one another, to said multiple video receiving apparatuses, comprising:

a password generation step in which a remote control apparatus for transmitting an operation signal with respect to said multiple video receiving apparatuses, or one video receiving apparatus among said multiple video receiving apparatuses generates said password based on said unique information retained by said one video receiving apparatus, and stores the password in a password storage unit provided in said remote control apparatus; and

a password transmitting step in which said remote control apparatus transmits said stored password to any other video receiving apparatus.

The second aspect of the present invention is the password setting method according to the first aspect of the present invention, further comprising:

a first unique information obtaining step in which said remote control apparatus obtains the unique information on said one video receiving apparatus from said one video receiving apparatus; and

a second unique information obtaining step in which, after said remote control apparatus has obtained said unique information on said one video receiving apparatus, said remote control apparatus obtains the unique information on said any other video receiving apparatus from said any other video receiving apparatus,

wherein in said password generation step, said remote control apparatus generates said password based on said unique information obtained from said one video receiving apparatus, transmits the password to said one video receiving apparatus, and further stores the password in said password storage unit, and

in said password transmitting step, after said remote control apparatus has obtained the unique information on said any other video receiving apparatus, said remote control apparatus transmits said stored password to said any other video receiving apparatus.

The third aspect of the present invention is the password setting method according to the first aspect of the present invention, further comprising a password generation request step in which said remote control apparatus requests said video receiving apparatus to generate said password,

wherein in said password generation step, said one video receiving apparatus generates said password based on said unique information retained therein and transmits the password to said remote control apparatus, and said remote control apparatus stores the transmitted password in said password storage unit.

The fourth aspect of the present invention is the password setting method according to the third aspect of the present invention, further comprising a unique information obtaining step in which, after said remote control apparatus has received said password transmitted from said one video receiving apparatus, said remote control apparatus obtains the unique information on said any other video receiving apparatus from said any other video receiving apparatus,

wherein in said password transmitting step, after said remote control apparatus has obtained the unique information on said any other video receiving apparatus, said remote control apparatus transmits said stored password to said any other video receiving apparatus.

The fifth aspect of the present invention is the password setting method according to the third aspect of the present invention, further comprising a determination step in which, when said remote control apparatus has requested said video receiving apparatus to generate said password, said remote control apparatus checks whether or not the password has been stored in said password storage unit,

wherein in said password transmitting step, based on a result of said check, (1) if the password has been stored in said password storage unit, said remote control apparatus transmits the stored password to the video receiving apparatus to which the generation of said password has been requested in said check, and (2) if the password has not been stored in said password storage unit, said remote control apparatus requests the video receiving apparatus to which the generation of said password has been requested in said check, to generate said password.

The sixth aspect of the present invention is a video receiving system, comprising:

multiple video receiving apparatuses which retain unique information different from one another and use a same password for connecting to a network; and

a remote control apparatus which has a password storage unit for storing said password, and transmits an operation signal with respect to said multiple video receiving apparatuses,

wherein said remote control apparatus or one video receiving apparatus among said multiple video receiving apparatuses generates said password based on said unique information retained by said one video receiving apparatus, and stores the password in said password storage unit, and

said remote control apparatus transmits said stored password to any other video receiving apparatus.

The seventh aspect of the present invention is the video receiving system according to the sixth aspect of the present invention, wherein said remote control apparatus has:

a unique information transmission request unit for requesting said video receiving apparatus to transmit said unique information;

a unique information receiving unit for receiving said unique information transmitted from said video receiving apparatus;

a password generation unit for generating the password based on said received unique information, to transmits the password to said video receiving apparatus corresponding to said received unique information, and to further store the password in said password storage unit;

a determination unit for checking whether or not the password has been stored in said password storage unit when said unique information has been received; and

a control unit for, based on a result of said check, (1) if the password has been stored in said password storage unit, transmitting the stored password to the video receiving apparatus corresponding to said unique information received in said check, and (2) if the password has not been stored in said password storage unit, causing said password generation unit to generate the password, and

wherein said video receiving apparatus has:

a unique information transmitting unit for transmitting said unique information in response to the request from said remote control apparatus for transmitting said unique information;

a password receiving unit for receiving the password transmitted from said remote control apparatus; and

a network connection unit for connecting to said network by using said received password.

The eighth aspect of the present invention is the video receiving system according to the seventh aspect of the present invention, wherein after said password generation unit has transmitted said generated password to said video receiving apparatus corresponding to said unique information, when said password generation unit receives a password storage completion reply from said video receiving apparatus, said password generation unit stores the password in said password storage unit.

The ninth aspect of the present invention is the video receiving system according to the seventh aspect of the present invention, wherein said multiple video receiving apparatuses connected to said network are a primary subscriber video receiving apparatus and a secondary subscriber video receiving apparatus;

said unique information transmitting unit transmits primary/secondary identification information for identifying whether said video receiving apparatus which is a transmitter is said primary subscriber video receiving apparatus or said secondary subscriber video receiving apparatus, with said unique information; and

said password generation unit does not generate said password if said transmitter is said secondary subscriber video receiving apparatus.

The tenth aspect of the present invention is the video receiving system according to the seventh aspect of the present invention, wherein said remote control apparatus has a password transmission completion storage unit for, when said remote control apparatus has transmitted said password to the video receiving apparatus, storing the unique information on the video receiving apparatus, and

when said remote control apparatus has received the unique information from said video receiving apparatus, if the unique information has already been stored in said password transmission completion storage unit, said remote control apparatus does not transmit said password to said video receiving apparatus corresponding to said received unique information.

The eleventh aspect of the present invention is the video receiving system according to the seventh aspect of the present invention, wherein said remote control apparatus has a limit number retention unit for retaining a connectability limit number of said video receiving apparatuses which can connect to said network, and

if the number of said video receiving apparatuses to which said password has previously been transmitted has reached said connectability limit number, said control unit does not subsequently transmit said password to the video receiving apparatus other than the video receiving apparatuses to which said password has already been transmitted.

The twelfth aspect of the present invention is the video receiving system according to the eleventh aspect of the present invention, wherein said remote control apparatus has a password transmission completion storage unit for, when said remote control apparatus has transmitted said password to said video receiving apparatus, storing the unique information on the video receiving apparatus, and

said control unit determines said number of said video receiving apparatuses based on the unique information stored in said password transmission completion storage unit.

The thirteenth aspect of the present invention is the video receiving system according to the eleventh aspect of the present invention, wherein said video receiving apparatus has:

a limit number obtaining unit for obtaining the connectability limit number transmitted from a predetermined management device by using a line for receiving a video signal; and

a limit number transmitting unit for transmitting said obtained connectability limit number to said remote control apparatus, and

wherein said remote control apparatus has a limit number receiving unit for receiving said connectability limit number from said video receiving apparatus, and causes said limit number retention unit to retain said received connectability limit number.

The fourteenth aspect of the present invention is the video receiving system according to the sixth aspect of the present invention, wherein said remote control apparatus has:

a password generation request unit for requesting said one video receiving apparatus to generate said password; and

a password receiving unit for receiving said password transmitted from said one video receiving apparatus, and

wherein said one video receiving apparatus has:

a password generation request receiving unit for receiving the request to generate said password from said remote control apparatus;

a password generation unit for, in response to said received request, generating the password based on said retained unique information to transmit the password to said remote control apparatus; and

a network connection unit for connecting to said network by using said generated password.

The fifteenth aspect of the present invention is the video receiving system according to the fourteenth aspect of the present invention, wherein said remote control apparatus has:

a unique information transmission request unit for requesting said any other video receiving apparatus to transmit said unique information;

a unique information receiving unit for receiving said unique information transmitted from said any other video receiving apparatus;

a determination unit for checking whether or not the password has been stored in said password storage unit when said unique information has been received; and

a control unit for, based on a result of said check, if the password has been stored in said password storage unit, transmitting the stored password to the video receiving apparatus corresponding to said unique information received in said check.

The sixteenth aspect of the present invention is the video receiving system according to the fourteenth aspect of the present invention, wherein said remote control apparatus has:

a determination unit for checking whether or not the password has been stored in said password storage unit when the generation of said password has been requested; and

a control unit for, based on a result of said check, (1) if the password has been stored in said password storage unit, transmitting the stored password to the video receiving apparatus to which the generation of said password has been requested in said check, and (2) if the password has not been stored in said password storage unit, requesting the video receiving apparatus to which the generation of said password has been requested in said check, to generate said password.

The seventeenth aspect of the present invention is a program on a computer-readable medium, which program causes a computer to act as the password generation step in which a remote control apparatus for transmitting an operation signal with respect to said multiple video receiving apparatuses, or one video receiving apparatus among said multiple video receiving apparatuses generates said password based on said unique information retained by said one video receiving apparatus, and stores the password in a password storage unit provided in said remote control apparatus and to act as the password transmitting step in which said remote control apparatus transmits said stored password to any other video receiving apparatus, in the password setting method of the first aspect of the present invention.

The eighteenth aspect of the present invention is a computer-readable recording medium of recording the program of the seventeenth aspect of the present invention.

The nineteenth aspect of the present invention is a method for setting a password within a plurality of video receiving apparatuses which are coupled to a common network, said method comprising the steps of:

generating said password;

storing said generated password within a remote controller which controls said plurality of video receiving apparatuses; and

transmitting said stored password to at least one of said-video receiving apparatuses in order to enable communication between said plurality of video receiving apparatuses and said network.

The twentieth aspect of the present invention is a system for setting a password within a plurality of video receiving apparatuses which are coupled to a common network, said system comprising:

a processing unit for generating said password; and

a remote controller for controlling said plurality of video receiving apparatuses, said remote controller having a) a storing unit for storing said generated password and b) a transmitting unit for transmitting said stored password to at least one of said video receiving apparatuses in order to enable communication between said plurality of video receiving apparatuses and said network.

According to the present invention, it is possible to provide the password setting method, the video receiving system, the program and the recording medium which set the password with respect to the video receiving apparatus connected via the network, in the convenient way for the user.

### BRIEF DESCRIPTION OF THE DRAWINGS

FIG. 1 is a connection configuration diagram of a video receiving system of a first embodiment of the present invention;

FIG. 2 is a configuration diagram of a remote control apparatus of the first embodiment of the present invention;

FIG. 3 is a configuration diagram of a video receiver of the first embodiment of the present invention;

FIG. 4 is a diagram showing a flowchart of the remote control apparatus when a password is set in the video receiving system of the first embodiment of the present invention;

FIG. 5 is a diagram showing a flowchart of the video receiver when the password is set in the video receiving system of the first embodiment of the present invention;

FIG. 6 is a connection configuration diagram of the video receiving system of a second embodiment of the present invention;

FIG. 7 is a configuration diagram of the remote control apparatus of the second embodiment of the present invention;

FIG. 8 is a configuration diagram of the video receiver of the second embodiment of the present invention;

FIG. 9 is a diagram showing a flowchart of the remote control apparatus when a password limit number is set to the remote control apparatus in the video receiving system of the second embodiment of the present invention;

FIG. 10 is a diagram showing a flowchart of the remote control apparatus when the password is set in the video receiving system of the second embodiment of the present invention;

FIG. 11 is a configuration diagram of the remote control apparatus of another embodiment of the present invention;

FIG. 12 is a configuration diagram of the video receiver of another embodiment of the present invention;

FIG. 13 is a configuration diagram of the remote control apparatus of further another embodiment of the present invention; and

FIG. 14 is a connection configuration diagram of a conventional network system.

### DESCRIPTION OF SYMBOLS

10, 44 Remote control apparatus
11 Receiving section
12 Transmitting section
13 Processing section
14 Password generation section
15 Password storage section
16 Remote control-control section
17 Unique information storage section
18 Determination section
19 Light transmitting and receiving section
20, 40, 41, 45, 46, 47 Video receiver
21 Video receiving section
22 Video processing section
23 Terminal control section
24 Accumulation unit
25 Receiving section
26 Processing section
27 Transmitting section
28 Password storage section
26 Network section
30 Unique information storage section
31 Light transmitting and receiving section
32 Two-way function section
33 Limit information storage section
35 Limit section
34 Notification LED
36 Transmission completion information storage section
38 Password setting button
39 New terminal addition button
42 Premise network
43 Cable television station

### PREFERRED EMBODIMENTS OF THE INVENTION

A best mode for carrying out the invention will be described below with reference to the drawings.

### First Embodiment

First, a configuration of a video receiving system of this embodiment will be described.

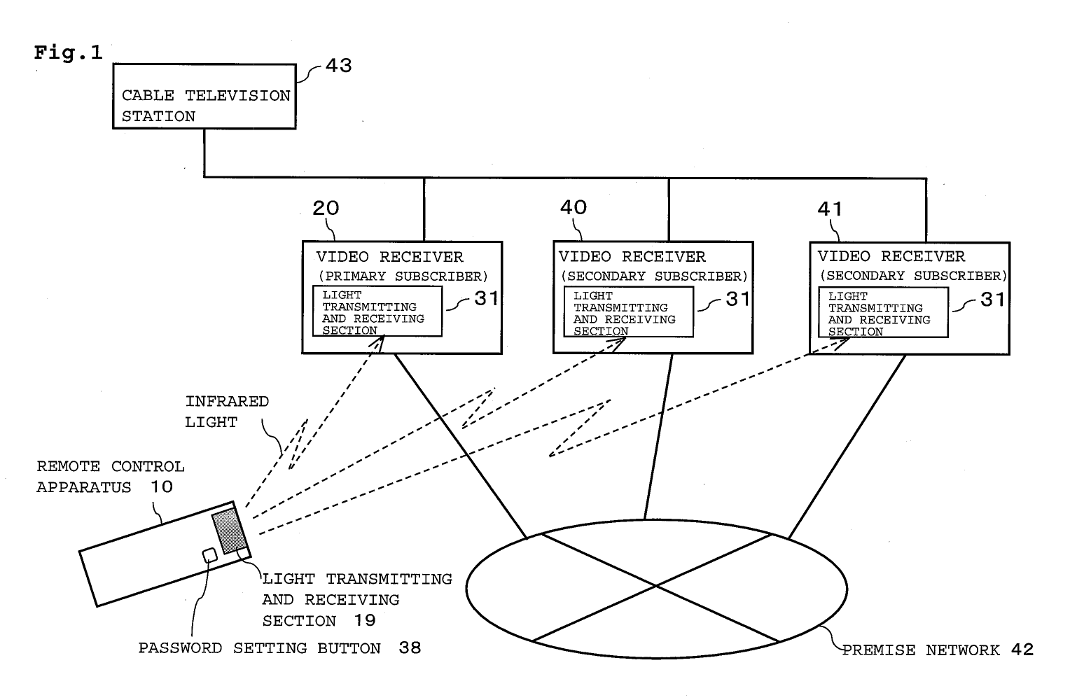

FIG. 1 shows a connection configuration diagram of the video receiving system of a first embodiment of the present invention.

Here, FIG. 1 shows an example of a connection form at a home owning three STBs lent by a cable television company. Video receivers 20, 40 and 41 are the three STBs owned by this home, and the video receivers 20, 40 and 41 receive a TV signal delivered by a cable television station 43 and display its video on a display device such as a television receiver.

A premise network 42 is connected to the video receivers 20, 40 and 41, and is a network which enables intercommunication among the video receivers 20, 40 and 41 by using a same password.

The STB used for a cable television is typically provided to a user in a form of rental. In this first embodiment, such a form in which one primary subscriber STB is placed at each home and the home subscribes for a second or later rental STB as a secondary subscriber STB for configuring the premise network in the home will be described as an example. In the configuration of FIG. 1, the video receiver 20 is the primary subscriber STB, and the video receivers 40 and 41 are the secondary subscriber STBs.

A cable operator distributes only one remote control having a password generation function for each one primary subscription. In other words, even if a home has subscribed for multiple STBs having a function of the primary subscriber STB (assuming that the primary subscriber STB has the function different from that of the secondary subscriber STB) with respect to one primary subscription, only one remote control having the password generation function is distributed to the home. A remote control apparatus 10 shown in FIG. 1 is the remote control having the password generation function. It should be noted that, of course, a form of service is not limited thereto.

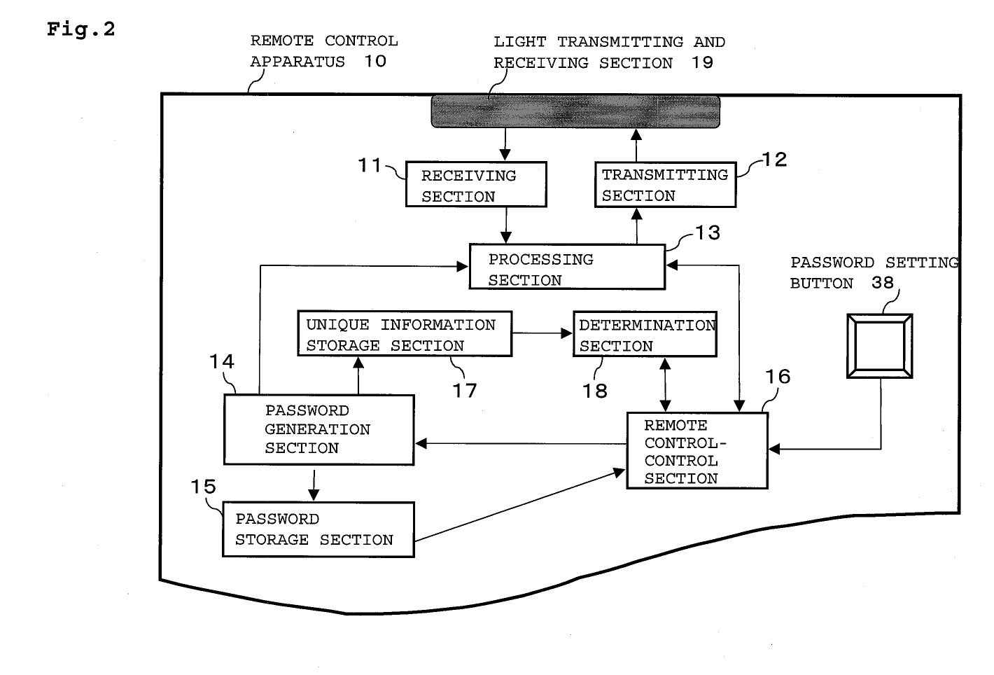

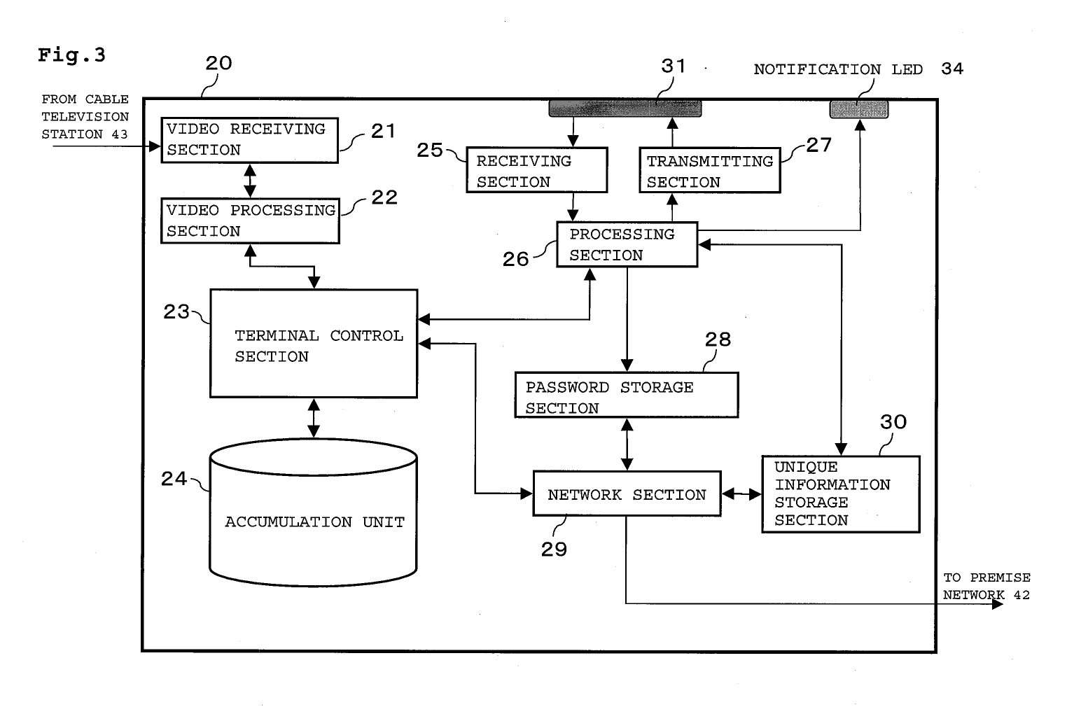

FIG. 2 shows a configuration diagram of the remote control apparatus 10 having the password generation function of this first embodiment, and FIG. 3 shows a configuration diagram of the video receiver 20. The same reference numerals have been used for the same component parts as those of FIG. 1. It should be noted that although a configuration of the video receivers 40 and 41 which are the secondary subscriber STBs may be different from that of the video receiver 20 which is the primary subscriber STB, it is assumed that the video receivers 40 and 41 have the same configuration as that of the video receiver 20 in this embodiment.

It should be noted that the remote control apparatus 10 of this first embodiment is a remote control capable of performing typical operations of the video receiver such as channel switching, and is also provided with the password generation function in addition to the typical operations.

As shown in FIG. 2, the remote control apparatus 10 of this first embodiment is provided with a light transmitting and receiving section 19 which emits and receives data transmitted to and received from the video receivers 20, 40 and 41, via an infrared light. Moreover, the remote control apparatus 10 is provided with a receiving section 11 which receives a signal received by the light transmitting and receiving section 19, and a transmitting section 12 which transmits a signal to be emitted from the light transmitting and receiving section 19.

Moreover, the remote control apparatus 10 is provided with a processing section 13 which processes the signal transmitted to and received from the respective video receivers 20, 40 and 41, a password generation section 14 which generates the password required for configuring the premise network 42, a password storage section 15 which stores the generated password, and a remote control-control section 16 which controls operations of the remote control apparatus 10.

Moreover, the remote control apparatus 10 is provided with a unique information storage section 17 which has stored unique information on the primary subscriber video receiver 20 to be used for generating the password for configuring the premise network 42. Also, the remote control apparatus 10 is provided with a determination section 18 which determines whether or not the unique information has been stored in the unique information storage section 17. It should be noted that no information has been stored in the unique information storage section 17 at the time of shipping. In other words, at the time when the user has obtained the remote control apparatus 10 from the cable television company, no information has been stored in the unique information storage section 17.

Moreover, at an outer side of the remote control apparatus 10, a password setting button 38 which is depressed by the user when setting the password and performs the password generation is provided.

It should be noted that the remote control apparatus 10 corresponds to an example of a remote control apparatus of the present invention. Moreover, the password setting button 38 corresponds to an example of a unique information transmission request unit of the present invention, and the receiving section 11 corresponds to an example of a unique information receiving unit of the present invention. Moreover, the password storage section 15 corresponds to an example of a password storage unit of the present invention, and the password generation section 14 corresponds to an example of a password generation unit of the present invention. Moreover, the determination section 18 corresponds to an example of a determination unit of the present invention, and the remote control-control section 16 corresponds to an example of a control unit of the present invention.

As shown in FIG. 3, the video receiver 20 of this first embodiment is provided with a video receiving section 21 which receives the TV signal delivered by the cable television station 43, a video processing section 22 which processes a received video, a terminal control section 23 which controls the entire operation of the video receiver 20, and an accumulation unit 24 which accumulates the received video.

Moreover, the video receiver 20 is provided with a light transmitting and receiving section 31 which emits and receives the data transmitted to and received from the remote control apparatus 10, via the infrared light. Moreover, the video receiver 20 is provided with a receiving section 25 which receives the signal transmitted from the remote control apparatus 10 and received by the light transmitting and receiving section 31, a transmitting section 27 which transmits the signal to be emitted from the light transmitting and receiving section 31, and a processing section 26 which processes the signal transmitted to and received from the remote control apparatus 10.

Moreover, the video receiver 20 is provided with a password storage section 28 which stores the password required for configuring the premise network 42, a network section 29 which controls the premise network 42, and a unique information storage section 30 in which the unique information on the video receiver 20 which is different for each video receiver has been retained.

Moreover, the video receiver 20 is provided with a notification LED 34 which notifies a state of the video receiver, a warning or the like with respect to the user.

It should be noted that the video receiver 20 corresponds to an example of a video receiving apparatus of the present invention. Moreover, the transmitting section 27 corresponds to an example of a unique information transmitting unit of the present invention, and the receiving section 25 corresponds to an example of a password receiving unit of the present invention. Moreover, the network section 29 corresponds to an example of a network connection unit of the present invention.

The user can view contents accumulated in the accumulation unit 24 within another video receiver connected via the premise network 42, by using the video receivers 20, 40 and 41 provided with the network section 29. In other words, the user can view the videos which have been accumulated in the video receiver installed in another room. When such a viewing form is realized, the password is required in order to configure the premise network 42 and assure security so that the network cannot be connected to from another home.

Hereinafter, while operations of the video receiving system of this embodiment will be described, a password setting method in the video receiving system of this first embodiment will be described by using FIGS. 1 to 5 (which is also similar in other embodiments).

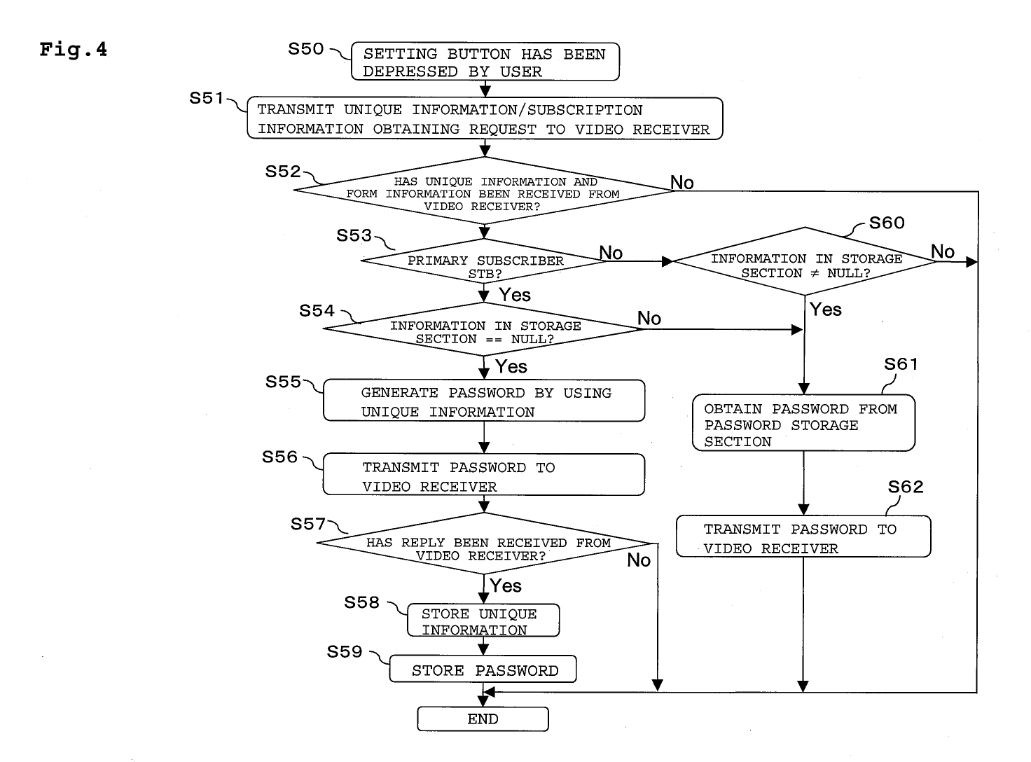

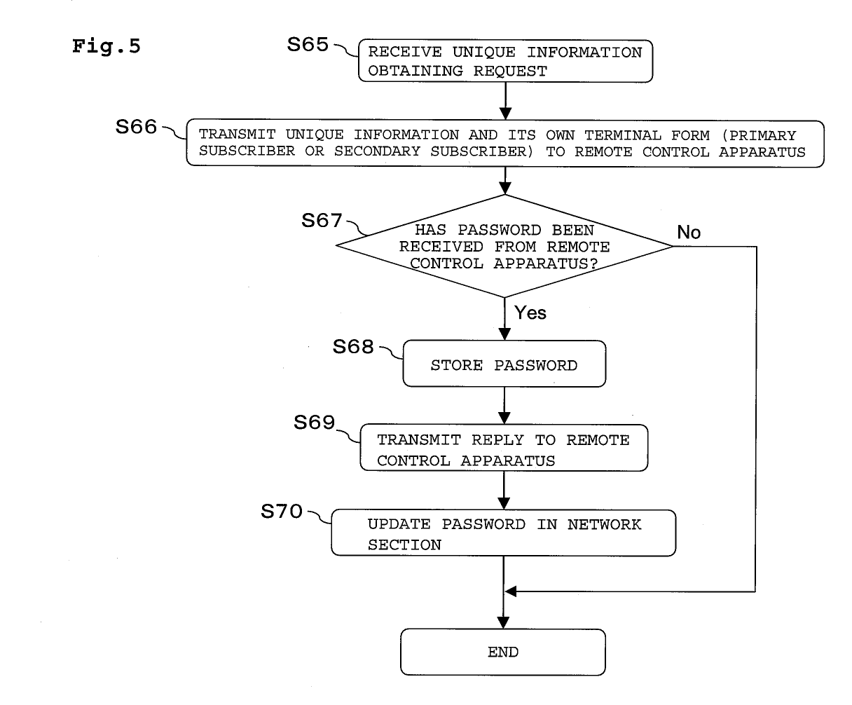

FIG. 4 is a flowchart showing the operations of the remote control apparatus 10 when the password is set to the respective video receivers 20, 40 and 41 in the video receiving system of this first embodiment, and FIG. 5 is a flowchart showing the operations of the video receiver 20 when the password is set.

First, the user aims the remote control apparatus 10 at the video receiver 20 which is the primary subscriber STB, and depresses the password setting button 38 (S50). Then, the remote control-control section 16 controls the processing section 13 and causes the transmitting section 12 to transmit a unique information/subscription information obtaining request to the video receiver 20 (S51).

Next, the operations of the video receiver 20 will be described.

The receiving section 25 receives the unique information/subscription information obtaining request from the remote control apparatus 10 (S65). Then, the processing section 26 determines that the received signal is the unique information/subscription information obtaining request, obtains the unique information (for example, a MAC address) and subscription form information (“primary subscriber” or “secondary subscriber”) on the video receiver 20 itself from the unique information storage section 30, and causes the transmitting section 27 to transmit the information to the remote control apparatus 10 (S66). It should be noted that, in the case of this first embodiment, as the subscription form information, information showing “primary subscriber” has been stored in the video receiver 20 and information showing “secondary subscriber” has been stored in the video receivers 40 and 41.

Next, subsequent operations of the remote control apparatus 10 will be described.

The receiving section 11 receives the unique information and the subscription form information from the video receiver 20 (S52). Then, the remote control-control section 16 extracts the unique information and the subscription form information on the video receiver 20 from the received data, and determines whether the video receiver 20 is the primary subscriber STB or the secondary subscriber STB (S53).

If it is determined that the video receiver 20 is the primary subscriber STB, the remote control-control section 16 causes the determination section 18 to confirm whether or not the information has already been stored in the unique information storage section 17 (S54).

At step S54, if the information has not yet been stored in the unique information storage section 17, the remote control-control section 16 causes the password generation section 14 to generate the password required for configuring the premise network 42 based on the unique information received from the video receiver 20 (S55). Then, when the generation of the password has been completed, the processing section 13 causes the transmitting section 12 to transmit the generated password to the video receiver 20 (S56).

When the receiving section 11 receives a storage completion reply from the video receiver 20 (S57), the remote control-control section 16 causes the unique information storage section 17 to store the unique information which has been received from the video receiver 20 and used by the password generation section 14 for generating the password (S58), and causes the password storage section 15 to store the password generated by the password generation section 14 (S59).

At step S54, if the information has already been stored in the unique information storage section 17, the determination section 18 determines that the video receiver which has transmitted the information is a second or later primary subscriber STB. Then, the remote control-control section 16 obtains the password stored in the password storage section 15 (S61), and causes the transmitting section 12 to transmit the password to the video receiver 20 (S62). In this way, the password setting process in the remote control apparatus 10 is completed.

At step S53, if it is determined that the video receiver which has transmitted the unique information is the secondary subscriber STB, the remote control-control section 16 causes the determination section 18 to confirm whether or not the information has been stored in the unique information storage section 17 (S60).

At this time, if the information has been stored in the unique information storage section 17, the determination section 18 determines that the password has already been generated by using the unique information on the primary subscriber STB. Then, the remote control-control section 16 obtains the password stored in the password storage section 15 (S61), and causes the transmitting section 12 to transmit the password to the video receiver 20 (S62).

At step S60, if the information has not been stored in the unique information storage section 17, the remote control-control section 16 determines that the password has not yet been generated by using the unique information on the primary subscriber STB. Then, the password setting process in the remote control apparatus 10 is completed.

Next, the operations of the video receiver 20 when the password is received from the remote control apparatus 10 will be described.

When the receiving section 25 receives the password transmitted from the remote control apparatus 10 (S67), the processing section 26 stores the password in the password storage section 28 (S68), and causes the transmitting section 27 to transmit the storage completion reply to the remote control apparatus 10 (S69). Finally, the terminal control section 23 sets the password to the network section 29 which configures the premise network 42 (S70).

It should be noted that although the operations of the video receiver have been described with respect to the video receiver 20 which is the primary subscriber STB, the video receivers 40 and 41 which are the secondary subscriber STBs perform exactly the same operations as those of the video receiver 20. Only the unique information and the subscription form information transmitted to the remote control apparatus 10 are different.

Therefore, after the password has been set to the video receiver 20, (1) when the user aims the remote control apparatus 10 at the video receiver 40 and depresses the password setting button 38, the password is set to the video receiver 40, and (2) when the user depresses the password setting button 38 toward the video receiver 41, the password is set to the video receiver 41. In this way, since the same password generated based on the unique information on the video receiver 20 is set to the video receivers 20, 40 and 41, respectively, these video receivers 20, 40 and 41 can communicate with one another via the premise network 42.

It should be noted that, in a state where the password has not been stored in the password storage section 15 of the remote control apparatus 10, if the user aims the remote control apparatus 10 at the video receiver 40 which is the secondary subscriber STB prior to the video receiver 20 which is the primary subscriber STB and depresses the password setting button 38, the password is neither generated nor transmitted to the video receiver 40. In such a case, a notification or the like may be given to the user so that the user can know a status at that time.

For example, in the case of this first embodiment, since the notification LED 34 is provided on each of the video receivers 20, 40 and 41 as shown in FIG. 3, (1) the notification LED 34 may be caused to emit a green color light if the password has been normally received, and (2) the notification LED 34 may be caused to emit a red color light if the password has not been able to be received. Moreover, for example, if the password has not been able to be transmitted, the remote control apparatus 10 may be caused to notify a warning that “the secondary subscriber STB cannot generate the password” or display a video showing “at first, please depress the password setting button toward the primary subscriber STB and generate the password” on the display device connected to the video receiver 40.

Moreover, in the video receiving system described in this first embodiment, it has been assumed that the primary subscriber STB is distinguished from the secondary subscriber STB. However, even in a video receiving system having a configuration including multiple video receivers in which the primary subscriber STB is not distinguished from the secondary subscriber STB, the password setting method of this first embodiment can be applied if the password is generated based on the unique information on the video receiver at which the user has aimed the remote control apparatus 10 first and depressed the password setting button 38. For example, the same password setting method can be applied by deleting steps S52, S53 and S60 and executing step S54 after step S51 in the flowchart shown in FIG. 4.

In this case, for example, it is assumed that the video receivers 20, 40 and 41 are video receivers having the same configuration respectively in which the primary subscriber STB is not distinguished from the secondary subscriber STB, and it is also assumed that the user has depressed the password setting button 38 toward the video receiver 40 first in the state where the password has not been stored in the password storage section 15 of the remote control apparatus 10. Then, the password is generated based on the unique information on the video receiver 40 and the password is set to the video receiver 40. Subsequently, when the user aims the remote control apparatus 10 at the video receivers 20 and 41 and depresses the password setting button 38, the same password generated based on the unique information on the video receiver 40 is set to the video receivers 20 and 41.

However, as described in this first embodiment, if the primary subscriber STB is distinguished from the secondary subscriber STB and the password cannot be generated based on the unique information on the secondary subscriber STB, since at least one primary subscriber STB is required in a legitimate subscription form, for example, it is possible to restrain such an unauthorized use in which the network is configured with only multiple secondary subscriber STBS.

It should be noted that although the function of generating the password based on the unique information by the password generation section 14 can be realized in hardware with a circuit configuration, the function can also be realized with a CPU which executes a program to perform calculation. Moreover, the unique information storage section 17 is, for example, a predetermined storage area in a flash memory or the like, and processes of determining whether or not the unique information has been stored in the unique information storage section 17 and the like, which are performed by the determination section 18, can also be realized in software by causing the CPU to execute the program. Moreover, the password storage section 15 is also, for example, a predetermined storage area in the flash memory or the like, and processes of reading the password stored in the password storage section 15 and the like, which are performed by the remote control-control section 16, can also be realized in software by causing the CPU to execute the program.

In the video receiving system of this first embodiment, since the password for configuring the premise network 42 is generated based on the unique information on the video receiver 20, a unique password is generated for each home, and a secure network can be configured without causing the user to think about a special password.

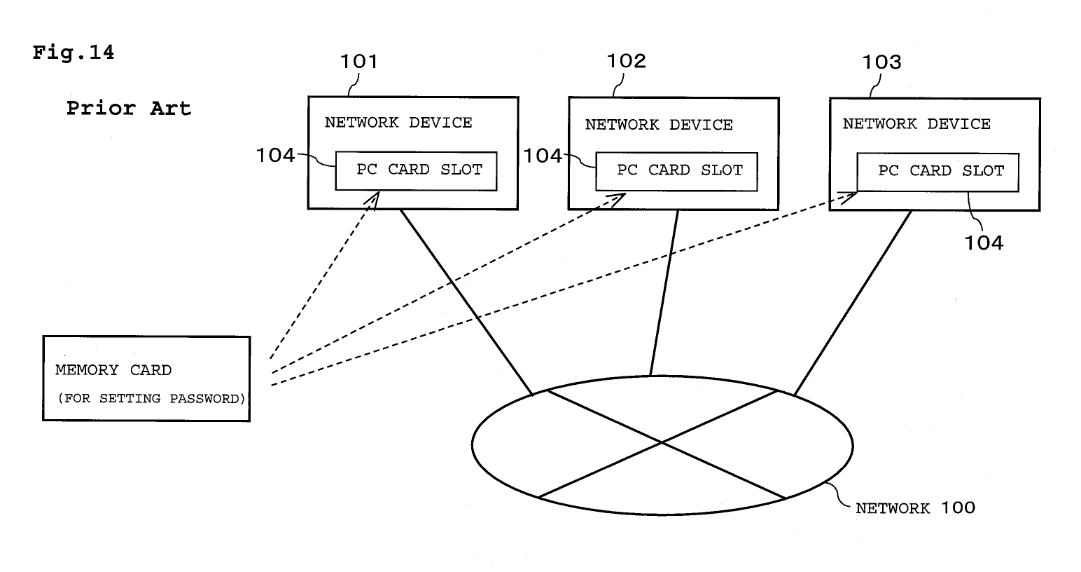

Moreover, in the conventional network system as shown in FIG. 14, the memory card 105, as well as the PC card slot 104 and its interface function in each of the network devices 101 to 103 are required for realizing a password setting function, which has been very costly. In contrast, in the video receiving system of this first embodiment, the function of the remote control apparatus which transmits an operation signal for the channel switching or the like, which is attached to the video receivers 20, 40 and 41, can be used for the password setting function. Therefore, the password setting function can be realized at low cost.

### Second Embodiment

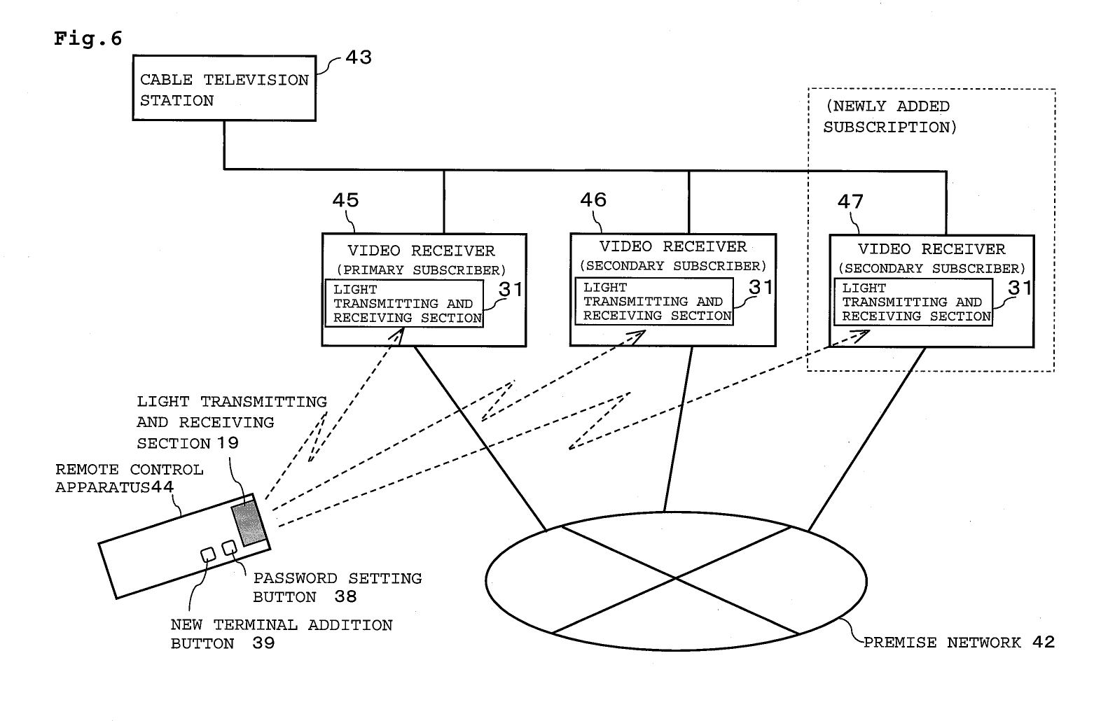

FIG. 6 shows a connection configuration diagram of the video receiving system of a second embodiment of the present invention.

The connection configuration is similar to the first embodiment shown in FIG. 1. However, FIG. 6 shows a case where the user who has previously subscribed for two video receivers newly subscribes for a third video receiver to add the third video receiver. More specifically, a video receiver 45 which is the primary subscriber STB and a video receiver 46 which is the secondary subscriber STB denote the two video receivers which have been previously subscribed for and used, and FIG. 6 shows a case where a video receiver 47 which is the secondary subscriber STB has been newly added as the third video receiver.

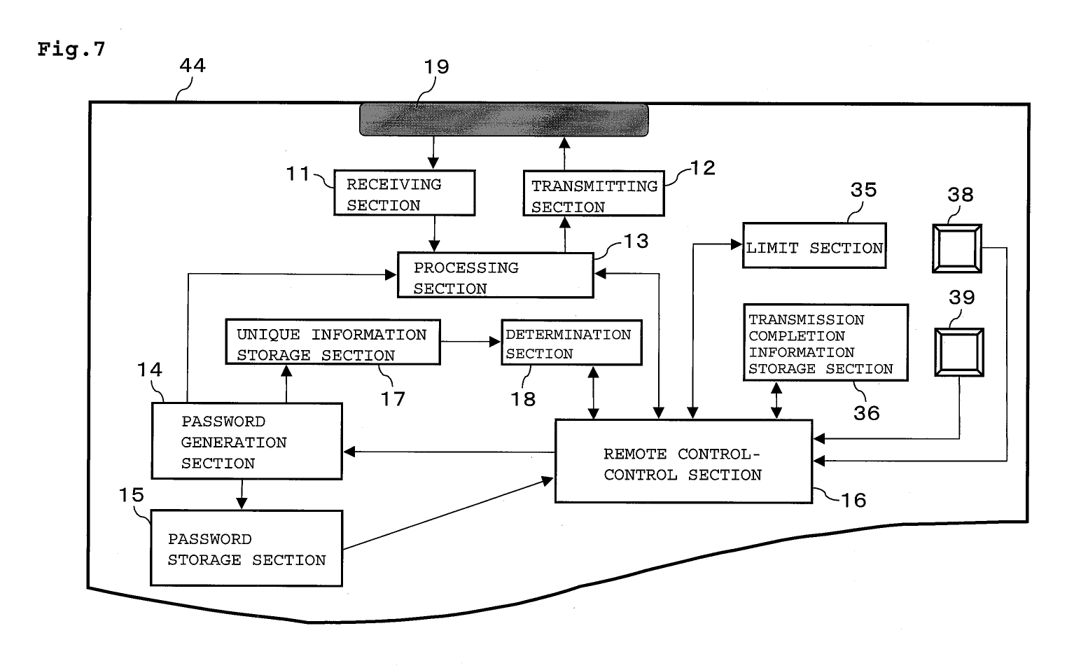

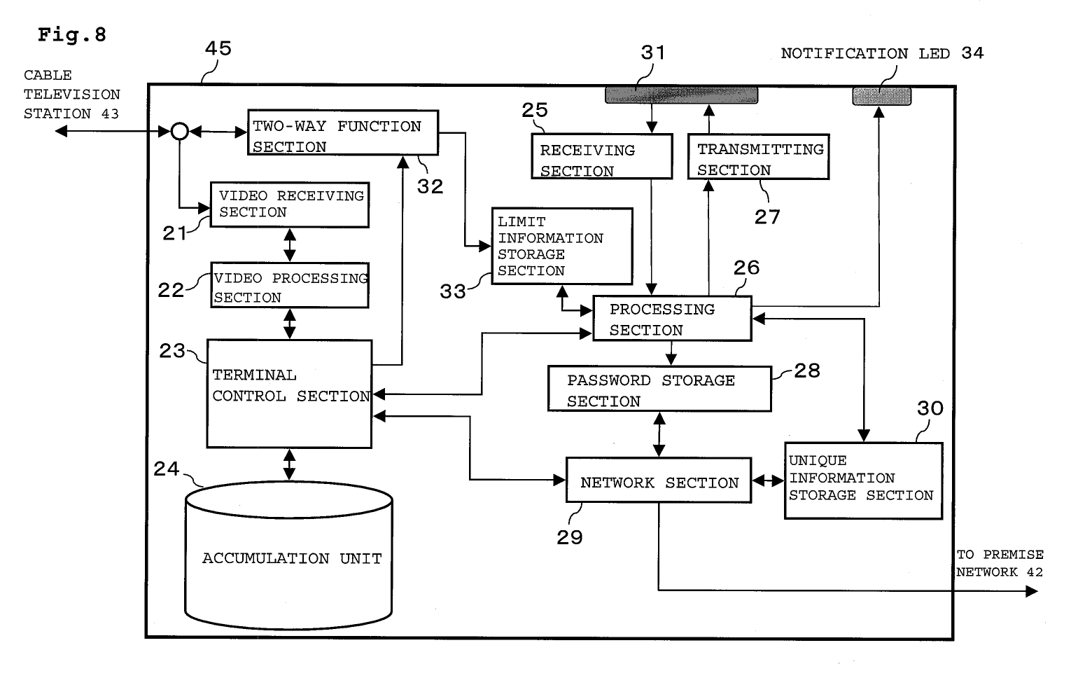

FIG. 7 shows a configuration diagram of the remote control apparatus of the video receiving system of this second embodiment, and FIG. 8 shows a configuration diagram of the video receiver. It should be noted that same reference numerals have been used for same component parts as those of FIGS. 2 and 3, respectively.

As shown in FIG. 7, in addition to the configuration of the remote control apparatus 10 of the first embodiment shown in FIG. 2, a remote control apparatus 44 of this second embodiment is provided with a limit section 35 which retains a password issuing limit number received from the video receiver, and a transmission completion information storage section 36 which stores the unique information on the video receiver to which the password has been transmitted. Moreover, at an outer side of the remote control apparatus 44, a new terminal addition button 39 which obtains information on the number of the subscriptions and is depressed by the user when the user has additionally subscribed for the new video receiver is provided.

It should be noted that the limit section 35 corresponds to an example of a limit number retention unit of the present invention, and the transmission completion information storage section 36 corresponds to an example of a password transmission completion storage unit of the present invention. Moreover, the receiving section 11 corresponds to an example of a limit number receiving unit of the present invention.

As shown in FIG. 8, in addition to components of the video receiver 20 of the first embodiment shown in FIG. 3, the video receiver 45 which is the primary subscriber STB of this second embodiment is provided with a two-way function section 32 which performs two-way communication with a management device of the cable television station 43, and a limit information storage section 33 which stores the password issuing limit number set by the management device.

The video receivers 46 and 47 which are the secondary subscriber STBs may be configured similarly to the video receiver 45 which is the primary subscriber STB, as shown in FIG. 8, or may be configured without being provided with the two-way function section 32, as shown in FIG. 3.

It should be noted that the two-way function section 32 corresponds to an example of a limit number obtaining unit of the present invention. Moreover the transmitting section 27 corresponds to an example of a limit number transmitting unit of the present invention.

Hereinafter, a password setting method in the video receiving system of this second embodiment in a case where the number of the subscriptions for the video receivers of the user has been increased will be described. Here, as shown in FIG. 6, a case where the user having the subscriptions for the two video receivers has subscribed for the third video receiver will be described.

The video receiver 45 which is the primary subscriber STB of this second embodiment can perform the two-way communication with the management device of the cable television station 43 by using the two-way function section 32.

Now, since the user has newly subscribed for the third video receiver, the cable television station 43 uses the management device to set a value of the password issuing limit number retained in the limit information storage section 33 of the video receiver 45 which is the primary subscriber STB to “2 (that is, a value obtained by subtracting 1, which is the number of the subscription for the video receiver 45 which is the primary subscriber STB, from 3, which is the number of the subscriptions for all video receivers)”, with a two-way communication function of the video receiver 45.

Subsequent operations of the video receiving system of this embodiment will be described mainly by using FIGS. 5, 9 and 10.

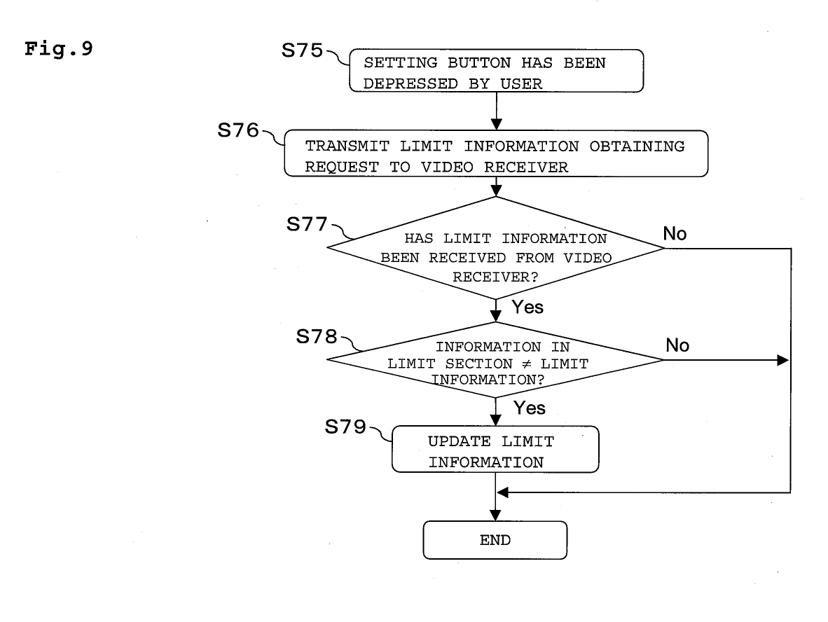

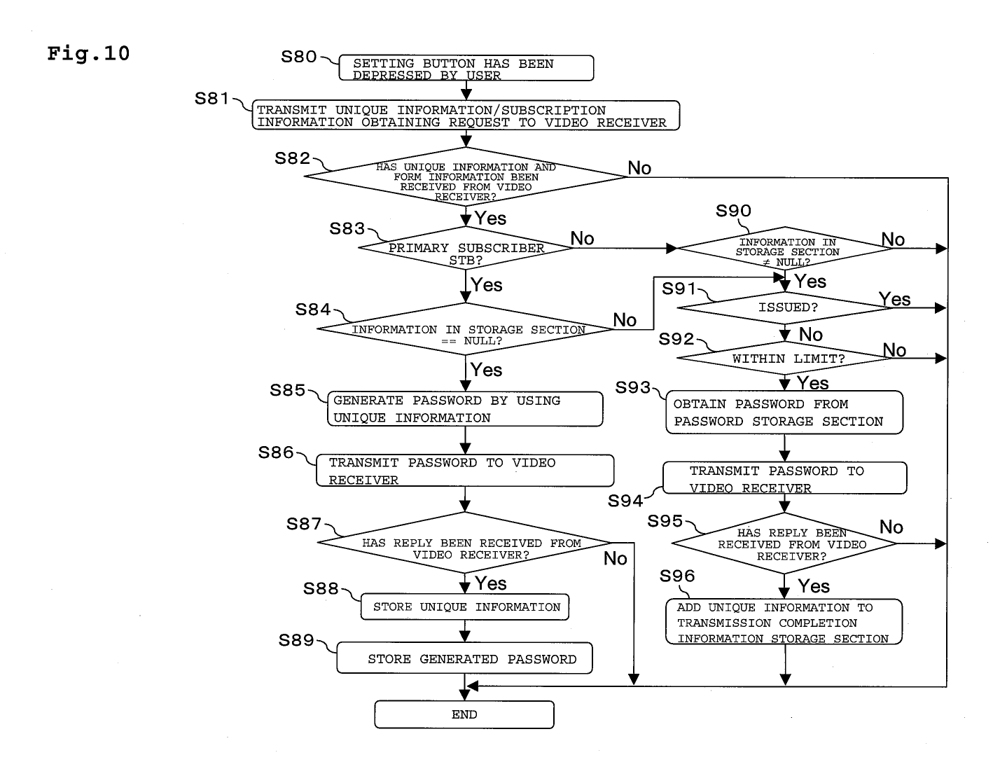

FIG. 9 is a flowchart showing operations of the remote control apparatus 44 when a password limit number is set to the remote control apparatus 44 in the video receiving system of this second embodiment, and FIG. 10 is a flowchart showing the operations of the remote control apparatus 44 when the password is set.

First, a method of setting the password limit number to the remote control apparatus 44 will be described.

When the third video receiver 47 has arrived at home, first, the user aims the remote control apparatus 44 at the video receiver 45 which is the primary subscriber STB and depresses the new terminal addition button 39 (S75). When the new terminal addition button 39 is depressed, the remote control-control section 16 controls the processing section 13 and causes the transmitting section 12 to transmit a limit information obtaining request to the video receiver 45 (S76).

In the video receiver 45, when the receiving section 25 receives the limit information obtaining request from the remote control apparatus 44, the processing section 26 obtains the password issuing limit number retained in the limit information storage section 33, and the transmitting section 27 transmits the password issuing limit number to the remote control apparatus 44.

In the remote control apparatus 44, the receiving section 11 receives the password issuing limit number from the video receiver 45 (S77). Then, the remote control-control section 16 compares the password issuing limit number stored in the limit section 35 with the password issuing limit number received from the video receiver 45 (S78).

If the values of these password issuing limit numbers are different, the remote control-control section 16 rewrites the password issuing limit number stored in the limit section 35 with the password issuing limit number newly received from the video receiver 45 (S79). If these values are equal, the remote control-control section 16 performs nothing.

In this way, the number of connectable video receivers is stored in the remote control apparatus 44.

Next, a method of setting the password required for configuring the premise network 42, with respect to the video receiver 47 which is the added secondary subscriber STB will be described.

The user aims the remote control apparatus 44 at the video receiver 47 which is the secondary subscriber STB, and depresses the password setting button 38 (S80). Then, the remote control-control section 16 controls the processing section 13 and causes the transmitting section 12 to transmit the unique information/subscription information obtaining request to the video receiver 47 (S81).

Next, operations of the video receiver 47 will be described.

The receiving section 25 receives the unique information/subscription information obtaining request from the remote control apparatus 44 (S65). Then, the processing section 26 determines that the received signal is the unique information/subscription information obtaining request, obtains the unique information (for example, the MAC address) and the subscription form information (“secondary subscriber” in this case) on the video receiver 47 itself from the unique information storage section 30, and causes the transmitting section 27 to transmit the information to the remote control apparatus 44 (S66).

Next, subsequent operations of the remote control apparatus 44 will be described.

The receiving section 11 receives the unique information and the subscription form information from the video receiver 47 (S82). Then, the remote control-control section 16 extracts the unique information and the subscription form information on the video receiver 47 from the received data, and determines whether the video receiver 47 is the primary subscriber STB or the secondary subscriber STB (S83).

Here, if it is determined that the video receiver is the primary subscriber STB, the remote control-control section 16 causes the determination section 18 to confirm whether or not the information has already been stored in the unique information storage section 17 (S84).

At step S84, if the information has not yet been stored in the unique information storage section 17, the remote control-control section 16 causes the password generation section 14 to generate the password required for configuring the premise network 42 based on the unique information received from the video receiver (S85). Then, when the generation of the password has been completed, the processing section 13 causes the transmitting section 12 to transmit the generated password to the video receiver which is the primary subscriber STB (S86).

When the receiving section 11 receives the storage completion reply from the video receiver which is the primary subscriber STB (S87), the remote control-control section 16 causes the unique information storage section 17 to store the unique information which has been used by the password generation section 14 for generating the password and has been received from the video receiver which is the primary subscriber STB (S88), and causes the password storage section 15 to store the password generated by the password generation section 14 (S89).

At step S84, if the information has already been stored in the unique information storage section 17, the remote control-control section 16 determines whether or not the password has already been issued to the video receiver having the unique information by seeing the unique information of which the issuing has been completed, which has been stored in the transmission completion information storage section 36 (S91). If the unique information on the video receiver has already been registered in the transmission completion information storage section 36, the remote control-control section 16 terminates the process without performing anything. If the unique information on the video receiver has not been registered in the transmission completion information storage section 36, the remote control-control section 16 determines that the video receiver is a video receiver to which the password has not been issued, and determines whether or not a issued number corresponding to the number of pieces of the unique information has not exceeded the issuing limit number (S92).

It should be noted that since the password has already been transmitted to the first primary subscriber STB (step S86), the video receiver in this case is the second or later primary subscriber STB to which the password has not yet been transmitted from the remote control apparatus 44.

Then, the remote control-control section 16 compares the issued number corresponding to the number of pieces of the unique information on the video receivers to which the password has already been transmitted, which has been stored in the transmission completion information storage section 36, with the password issuing limit number retained by the limit section 35, and if these numbers are equal, the remote control-control section 16 terminates the process without performing anything. If the password issuing limit number retained by the limit section 35 is more than the issued number, the remote control-control section 16 determines that the issued number has not exceeded the issuing limit number, obtains the password stored in the password storage section 15 (S93), and causes the transmitting section 12 to transmit the password to the video receiver which is the primary subscriber STB (S94).

When the receiving section 11 receives the storage completion reply from the video receiver (S95), the remote control-control section 16 causes the transmission completion information storage section 36 to additionally store the unique information on the video receiver (S96). It should be noted that if the receiving section 11 has not received the storage completion reply, the remote control-control section 16 terminates the process without performing anything.

At step S83, if the remote control-control section 16 determines that the video receiver which has transmitted the unique information is the secondary subscriber STB, the remote control-control section 16 causes the determination section 18 to confirm whether or not the information has been stored in the unique information storage section 17 (S90).

Hereinafter, a case where the unique information received by the remote control apparatus 44 is the unique information received from the video receiver 47 which is the secondary subscriber STB will be described.

At step S90, if the information has already been stored in the unique information storage section 17, the remote control-control section 16 determines whether or not the password has already been issued to the video receiver having the unique information by seeing the unique information of which the issuing has been completed, which has been stored in the transmission completion information storage section 36 (S91). If the unique information on the video receiver has already been registered in the transmission completion information storage section 36, the remote control-control section 16 terminates the process without performing anything. If the unique information on the video receiver has not been registered in the transmission completion information storage section 36, the remote control-control section 16 determines that the video receiver is a video receiver to which the password has not been issued, and determines whether or not the issued number corresponding to the number of pieces of the unique information has not exceeded the issuing limit number (S92).

Then, the remote control-control section 16 compares the issued number corresponding to the number of pieces of the unique information on the video receivers to which the password has already been transmitted, which has been stored in the transmission completion information storage section 36, with the password issuing limit number retained by the limit section 35, and if these numbers are equal, the remote control-control section 16 terminates the process without performing anything. If the password issuing limit number retained by the limit section 35 is more than the issued number, the remote control-control section 16 determines that the issued number has not exceeded the issuing limit number, obtains the password stored in the password storage section 15 (S93), and causes the transmitting section 12 to transmit the password to the video receiver 47 (S94).

When the receiving section 11 receives the storage completion reply from the video receiver 47 (S95), the remote control-control section 16 causes the transmission completion information storage section 36 to additionally store the unique information on the video receiver 47 (S96). It should be noted that if the receiving section 11 has not received the storage completion reply, the remote control-control section 16 terminates the process without performing anything.

In the video receiving system of this second embodiment, since the number of the passwords to be issued is only the number of the subscriptions, it is possible to restrain an unauthorized use of services even if the user tries the unauthorized use by bringing the video receiver from another place. Moreover, since it is possible to prevent the unauthorized use of the services only by managing the number of the subscriptions, it is possible for the cable television station to keep a management cost low without managing all video receivers.

It should be noted that there has been a problem as described below if the conventional network system as shown in FIG. 14 has been applied to a cable television system.

For example, an operator of the cable television system does not manage all terminals installed in a premise (particularly, the STBs of the secondary subscriber form) since such management is very costly. Therefore, for example, if the user tries to connect an STB brought from another cable television station (an unauthorized STB from a viewpoint of the cable television station) to the premise network, the user can also set the password to the unauthorized STB in the conventional network system. Thereby, it is possible for the user to freely connect to the premise network and use premise network services.

In other words, it has been impossible for the cable television station to solve such a problem of the unauthorized use of the services without paying a huge management cost.

In contrast, in the video receiving system of this second embodiment, even if the user tries to connect such an unauthorized STB to the premise network, since the number of the video receivers which can connect to the premise network is managed by the remote control apparatus 44, the password cannot be set to the unauthorized STB and the unauthorized STB cannot connect to the premise network. In other words, such an unauthorized use can be prevented without paying the huge management cost.

It should be noted that, in the above described first and second embodiments, the communication between the remote control apparatus and the video receiver has been the communication via wireless connection using the infrared light. However, the communication between the remote control apparatus and the video receiver may be the communication via wireless connection using radio waves, ultrasonic waves or the like, or may be the communication via wired connection.

Moreover, in the above described first and second embodiments, the video receiver has been the STB used for the cable television. However, the video receiver may be a video receiver which is not the STB but includes a function capable of configuring the premise network.

Moreover, in the above described first and second embodiments, the password has been generated at the remote control apparatus side. For example, unauthorized apparatuses and the like may be distributed in a market, and it may be necessary to generate a more robust password to assure the security. When the password is generated at the remote control apparatus side, for example, if it is necessary to generate such a more robust password, the security of the video receiving system can be improved at low cost only by distributing a new remote control apparatus provided with a program which generates the more robust password to the user, without modifying the configuration of the video receiver which is relatively expensive.

Aside from this, the password may be generated, for example, at the video receiver side. When the password is generated at the video receiver side, for example, if it is necessary to generate the more robust password as described above, the security of the video receiving system can be easily improved only by downloading the program which generates the more robust password, via the network to the video receiver, with little effort from the user.

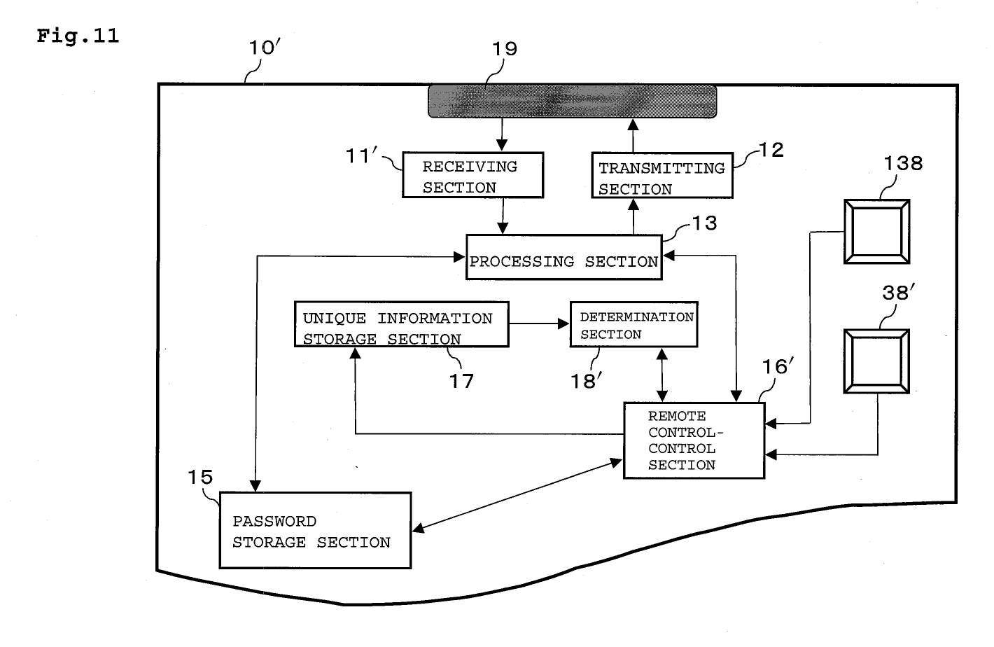

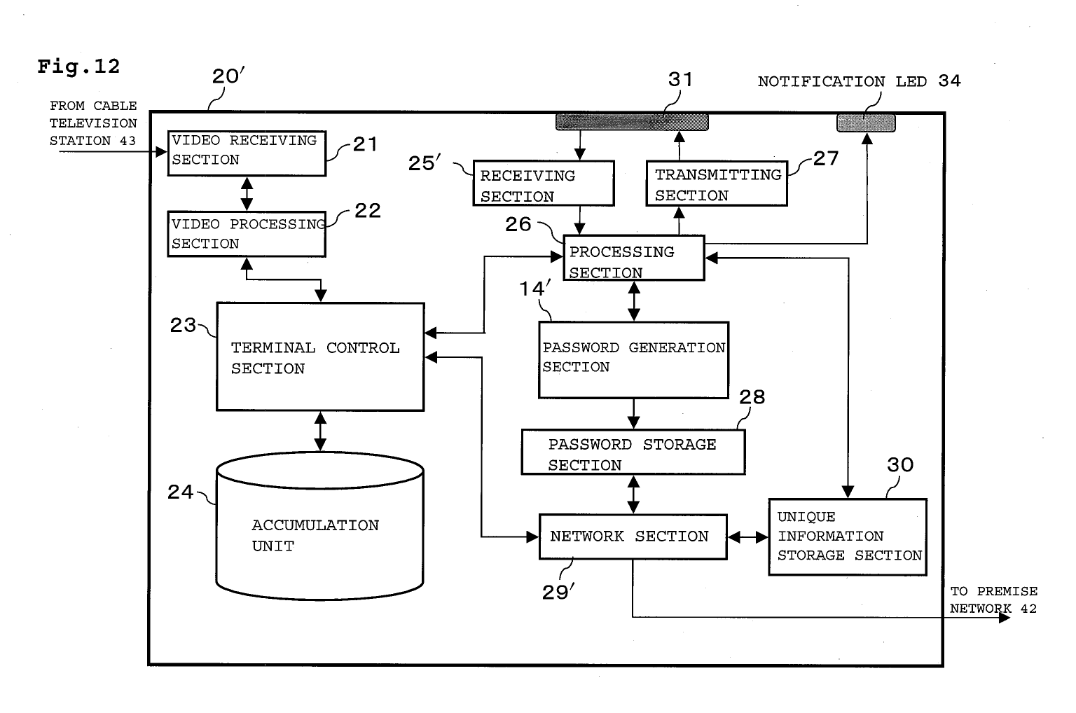

Consequently, another embodiment of the present invention related to a video receiving system provided with a remote control apparatus 10′ and a video receiver 20′ in which the password is generated at the video receiver side will be described with reference to FIGS. 11 and 12.

It should be noted that FIG. 11 is a configuration diagram of the remote control apparatus of another embodiment of the present invention, and FIG. 12 is a configuration diagram of the video receiver of another embodiment of the present invention.

As shown in FIG. 11, the remote control apparatus 10′ has a password generation button 138 which requests the video receiver 20′ to generate the password, a password setting button 38′ which requests any other video receiver to transmit the unique information, and a receiving section 11′ which receives the password transmitted from the video receiver 20′ or the unique information transmitted from any other video receiver. Moreover, the remote control apparatus 10′ has a determination section 18′ which checks whether or not the password has been stored in the password storage section 15 when the unique information has been received, and a remote control-control section 16′ which, based on a result of the check, if the password has been stored in the password storage section 15, transmits the stored password to the video receiver corresponding to the unique information received in the check.

It should be noted that the remote control apparatus 10′ corresponds to an example of the remote control apparatus of the present invention. Moreover, the password generation button 138 corresponds to an example of a password generation request unit of the present invention, the password setting button 381 corresponds to an example of the unique information transmission request unit of the present invention, and the receiving section 11′ corresponds to both an example of the password receiving unit of the present invention and an example of the unique information receiving unit of the present invention. Moreover, the determination section 18′ corresponds to an example of the determination unit of the present invention, and the remote control-control section 16′ corresponds to an example of the control unit of the present invention.

As shown in FIG. 12, the video receiver 20′ has a receiving section 25′ which receives the request to generate the password from the remote control apparatus 10′, a password generation section 14′ which generates the password based on the retained unique information in response to the received request and transmits the password to the remote control apparatus 10′, and a network section 29′ which uses the generated password to connect to the network.

It should be noted that the video receiver 20′ corresponds to an example of the video receiving apparatus of the present invention. Moreover, the receiving section 25′ corresponds to an example of a password generation request receiving unit of the present invention, and the password generation section 14′ corresponds to an example of the password generation unit of the present invention. Moreover, the network section 29′ corresponds to an example of the network connection unit of the present invention.

Incidentally, in the above described another embodiment of the present invention, the configuration of the remote control apparatus has been a configuration of using two buttons, that is, the password generation button 138 and the password setting button 38′.

Aside from this, the configuration of the remote control apparatus may be, for example, a configuration of using only one button. If the configuration of using only one button is employed, for example, the number of parts can be reduced.

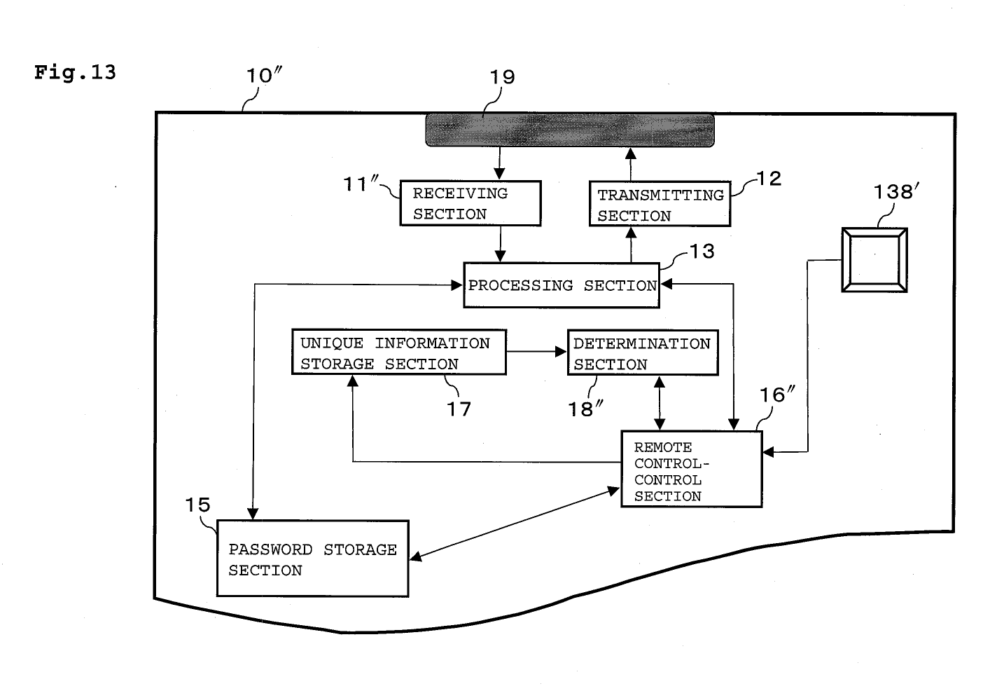

Consequently, further another embodiment of the present invention related to a video receiving system provided with a remote control apparatus 10″ having the configuration of using only one button and the video receiver 20′ (see FIG. 12) will be described with reference to FIG. 13.

It should be noted that FIG. 13 is a configuration diagram of the remote control apparatus of further another embodiment of the present invention.

The remote control apparatus 10″ has a password generation button 138′ which requests the video receiver 20′ to generate the password, and a receiving section 11″ which receives the password transmitted from the video receiver 20′. Moreover, the remote control apparatus 10″ has a determination section 18″ which checks whether or not the password has been stored in the password storage section 15 when the generation of the password has been requested, and a remote control-control section 16″ which, based on a result of the check, (1) if the password has been stored in the password storage section 15, transmits the stored password to the video receiver to which the generation of the password has been requested in the check, and (2) if the password has not been stored in the password storage section 15, requests the video receiver to which the generation of the password has been requested in the check, to generate the password.

It should be noted that the remote control apparatus 10″ corresponds to an example of the remote control apparatus of the present invention. Moreover, the password generation button 138′ corresponds to an example of the password generation request unit of the present invention, and the receiving section 11″ corresponds to an example of the password receiving unit of the present invention. Moreover, the determination section 18″ corresponds to an example of the determination unit of the present invention, and the remote control-control section 16″ corresponds to an example of the control unit of the present invention.

Moreover, a program of the present invention or any invention relating to the present invention is a program which causes a computer to execute the operations of all or some of the steps (or processes, operations, actions and the like) of the above described password setting method of the present invention, and is a program which operates in cooperation with the computer.

Moreover, a recording medium of the present invention or any invention relating to the present invention is a recording medium which has recorded the program which causes the computer to execute all or some of the operations of all or some of the steps (or processes, operations, actions and the like) of the above described password setting method of the present invention, and is a computer readable recording medium in which the above described program which has been read is used in cooperation with the above described computer.

It should be noted that the above described “some of the steps (or processes, operations, actions and the like)” means one or some steps among those multiple steps.

Moreover, the above described “the operations of the steps (or processes, operations, actions and the like)” means all or some of the operations of the above described steps.

Moreover, one form of usage of the program of the present invention may be an aspect of being transmitted in a transmission medium such as the Internet or a transmission medium such as the light, the radio wave, a sound wave or the like and read by the computer, and operating in cooperation with the computer.

Moreover, the recording medium includes a ROM and the like.

Moreover, the above described computer of the present invention is not limited to pure hardware such as the CPU, and may include firmware, an OS, and further a peripheral device.

As described above, it should be noted that the configuration of the present invention may be realized in software or may be realized in hardware.

As described above, according to the present invention, it is possible to use the remote control attached to the video receiving apparatus to easily establish the premise network configuration for each premise without causing the user to be conscious of managing the password. Moreover, since the number of the passwords issued from the remote control to the image receiving apparatus is managed, it is possible to prevent the unauthorized use of the services in system operation. Therefore, the present invention is effective as the remote control, the video receiver and the like which uniquely set the password for the premise network for each premise.

The password setting method, the video receiving system, the program and the recording medium according to the present invention have an advantage of being capable of setting the password with respect to the video receiving apparatus connected via the network, in a convenient way for the user. Therefore, they are useful as the password setting method, the video receiving system, the program and the recording medium.

What is claimed is:

1. A password setting method for setting a same password used for connecting to a network by multiple video receiving apparatuses retaining unique information different from one another, to said multiple video receiving apparatuses, comprising:
a password generation step in which a remote control apparatus for transmitting an operation signal with respect to said multiple video receiving apparatuses, or one video receiving apparatus among said multiple video receiving apparatuses generates said password based on said unique information retained by said one video receiving apparatus, and stores the password in a password storage unit provided in said remote control apparatus; and
a password transmitting step in which said remote control apparatus transmits said stored password to any other video receiving apparatus.

2. The password setting method according to claim 1, further comprising:
a first unique information obtaining step in which said remote control apparatus obtains the unique information on said one video receiving apparatus from said one video receiving apparatus; and
a second unique information obtaining step in which, after said remote control apparatus has obtained said unique information on said one video receiving apparatus, said remote control apparatus obtains the unique information on said any other video receiving apparatus from said any other video receiving apparatus,
wherein in said password generation step, said remote control apparatus generates said password based on said unique information obtained from said one video receiving apparatus, transmits the password to said one video receiving apparatus, and further stores the password in said password storage unit, and
in said password transmitting step, after said remote control apparatus has obtained the unique information on said any other video receiving apparatus, said remote control apparatus transmits said stored password to said any other video receiving apparatus.

3. The password setting method according to claim 1, further comprising a password generation request step in which said remote control apparatus requests said video receiving apparatus to generate said password,
wherein in said password generation step, said one video receiving apparatus generates said password based on said unique information retained therein and transmits the password to said remote control apparatus, and said remote control apparatus stores the transmitted password in said password storage unit.

4. The password setting method according to claim 3, further comprising a unique information obtaining step in which, after said remote control apparatus has received said password transmitted from said one video receiving apparatus, said remote control apparatus obtains the unique information on said any other video receiving apparatus from said any other video receiving apparatus,
wherein in said password transmitting step, after said remote control apparatus has obtained the unique information on said any other video receiving apparatus, said remote control apparatus transmits said stored password to said any other video receiving apparatus.

5. The password setting method according to claim 3, further comprising a determination step in which, when said remote control apparatus has requested said video receiving apparatus to generate said password, said remote control apparatus checks whether or not the password has been stored in said password storage unit,
wherein in said password transmitting step, based on a result of said check, (1) if the password has been stored in said password storage unit, said remote control apparatus transmits the stored password to the video receiving apparatus to which the generation of said password has been requested in said check, and (2) if the password has not been stored in said password storage unit, said remote control apparatus requests the video receiving apparatus to which the generation of said password has been requested in said check, to generate said password.

6. A video receiving system, comprising:
multiple video receiving apparatuses which retain unique information different from one another and use a same password for connecting to a network; and
a remote control apparatus which has a password storage unit for storing said password, and transmits an operation signal with respect to said multiple video receiving apparatuses,
wherein said remote control apparatus or one video receiving apparatus among said multiple video receiving apparatuses generates said password based on said unique information retained by said one video receiving apparatus, and stores the password in said password storage unit, and
said remote control apparatus transmits said stored password to any other video receiving apparatus.

7. The video receiving system according to claim 6, wherein said remote control apparatus has:
a unique information transmission request unit for requesting said video receiving apparatus to transmit said unique information;
a unique information receiving unit for receiving said unique information transmitted from said video receiving apparatus;
a password generation unit for generating the password based on said received unique information, to transmits the password to said video receiving apparatus corresponding to said received unique information, and to further store the password in said password storage unit;
a determination unit for checking whether or not the password has been stored in said password storage unit when said unique information has been received; and
a control unit for, based on a result of said check, (1) if the password has been stored in said password storage unit, transmitting the stored password to the video receiving apparatus corresponding to said unique information received in said check, and (2) if the password has not been stored in said password storage unit, causing said password generation unit to generate the password, and
wherein said video receiving apparatus has:
a unique information transmitting unit for transmitting said unique information in response to the request from said remote control apparatus for transmitting said unique information;
a password receiving unit for receiving the password transmitted from said remote control apparatus; and
a network connection unit for connecting to said network by using said received password.

8. The video receiving system according to claim 7, wherein after said password generation unit has transmitted said generated password to said video receiving apparatus corresponding to said unique information, when said password generation unit receives a password storage completion reply from said video receiving apparatus, said password generation unit stores the password in said password storage unit.

9. The video receiving system according to claim 7, wherein said multiple video receiving apparatuses connected to said network are a primary subscriber video receiving apparatus and a secondary subscriber video receiving apparatus;
said unique information transmitting unit transmits primary/secondary identification information for identifying whether said video receiving apparatus which is a transmitter is said primary subscriber video receiving apparatus or said secondary subscriber video receiving apparatus, with said unique information; and
said password generation unit does not generate said password if said transmitter is said secondary subscriber video receiving apparatus.

10. The video receiving system according to claim 7, wherein said remote control apparatus has a password transmission completion storage unit for, when said remote control apparatus has transmitted said password to the video receiving apparatus, storing the unique information on the video receiving apparatus, and
when said remote control apparatus has received the unique information from said video receiving apparatus, if the unique information has already been stored in said password transmission completion storage unit, said remote control apparatus does not transmit said password to said video receiving apparatus corresponding to said received unique information.

11. The video receiving system according to claim 7, wherein said remote control apparatus has a limit number retention unit for retaining a connectability limit number of said video receiving apparatuses which can connect to said network, and
if the number of said video receiving apparatuses to which said password has previously been transmitted has reached said connectability limit number, said control unit does not subsequently transmit said password to the video receiving apparatus other than the video receiving apparatuses to which said password has already been transmitted.

12. The video receiving system according to claim 11, wherein said remote control apparatus has a password transmission completion storage unit for, when said remote control apparatus has transmitted said password to said video receiving apparatus, storing the unique information on the video receiving apparatus, and
said control unit determines said number of said video receiving apparatuses based on the unique information stored in said password transmission completion storage unit.

13. The video receiving system according to claim 11, wherein said video receiving apparatus has:
a limit number obtaining unit for obtaining the connectability limit number transmitted from a predetermined management device by using a line for receiving a video signal; and
a limit number transmitting unit for transmitting said obtained connectability limit number to said remote control apparatus, and
wherein said remote control apparatus has a limit number receiving unit for receiving said connectability limit number from said video receiving apparatus, and causes said limit number retention unit to retain said received connectability limit number.

14. The video receiving system according to claim 6, wherein said remote control apparatus has:
a password generation request unit for requesting said one video receiving apparatus to generate said password; and
a password receiving unit for receiving said password transmitted from said one video receiving apparatus, and
wherein said one video receiving apparatus has:
a password generation request receiving unit for receiving the request to generate said password from said remote control apparatus;
a password generation unit for, in response to said received request, generating the password based on said retained unique information to transmit the password to said remote control apparatus; and
a network connection unit for connecting to said network by using said generated password.

15. The video receiving system according to claim 14, wherein said remote control apparatus has:
a unique information transmission request unit for requesting said any other video receiving apparatus to transmit said unique information;
a unique information receiving unit for receiving said unique information transmitted from said any other video receiving apparatus;
a determination unit for checking whether or not the password has been stored in said password storage unit when said unique information has been received; and
a control unit for, based on a result of said check, if the password has been stored in said password storage unit, transmitting the stored password to the video receiving apparatus corresponding to said unique information received in said check.

16. The video receiving system according to claim 14, wherein said remote control apparatus has:
a determination unit for checking whether or not the password has been stored in said password storage unit when the generation of said password has been requested; and
a control unit for, based on a result of said check, (1) if the password has been stored in said password storage unit, transmitting the stored password to the video receiving apparatus to which the generation of said password has been requested in said check, and (2) if the password has not been stored in said password storage unit, requesting the video receiving apparatus to which the generation of said password has been requested in said check, to generate said password.

17. A program on a computer-readable medium, which program causes a computer to act as the password generation step in which a remote control apparatus for transmitting an operation signal with respect to said multiple video receiving apparatuses, or one video receiving apparatus among said multiple video receiving apparatuses generates said password based on said unique information retained by said one video receiving apparatus, and stores the password in a password storage unit provided in said remote control apparatus and to act as the password transmitting step in which said remote control apparatus transmits said stored password to any other video receiving apparatus, in the password setting method of claim 1.

18. A computer-readable recording medium of recording the program of claim 17.

19. A method for setting a password within a plurality of video receiving apparatuses which are coupled to a common network, said method comprising the steps of:
generating said password;
storing said generated password within a remote controller which controls said plurality of video receiving apparatuses; and
transmitting said stored password to at least one of said-video receiving apparatuses in order to enable communication between said plurality of video receiving apparatuses and said network.

20. A system for setting a password within a plurality of video receiving apparatuses which are coupled to a common network, said system comprising:
a processing unit for generating said password; and
a remote controller for controlling said plurality of video receiving apparatuses, said remote controller having a) a storing unit for storing said generated password and b) a transmitting unit for transmitting said stored password to at least one of said video receiving apparatuses in order to enable communication between said plurality of video receiving apparatuses and said network.
